(19) United States
(12) Patent Application Publication
(10) Pub. No.: US 2006/0077058 A1
(43) Pub. Date: Apr. 13, 2006

(54) Luggage locator

(76) Inventor: Del Asher, Boerne, TX (US)

Correspondence Address: Robert L. Greeson;7th Floor, 900 Washington Avenue, P.O. Box 1470, Waco, TX, 77603-1470, US

(21) Appl. No.: 10/962,977

(22) Filed: Oct. 12, 2004

(51) Int. Cl. G08B 13/14

(52) U.S. Cl. 340/568.7

(57) ABSTRACT

An improved luggage locator comprised of a remote member and a replacement luggage tag member. The remote member activates the luggage tag member by transmission of some electromagnetic signal. The luggage tag member is configured to attach to standard luggage members and reversibly receives and illuminates information cards and the like. The luggage tag member contains a battery member, an microprocessor, a receiving means, a motion sensing means, and a light emitting means where the combination of such components is responsive to signals received from said remote member. Finally, the remote member is of compact arrangement and employs the use of simple buttons throughout its operation.

### BACKGROUND OF THE INVENTION

1. Field of the Invention

The present invention generally relates to an improved luggage locator. More specifically, the present invention relates to an improved luggage locator where a remote piece is in communication with an attachable piece.

2. Background Information

The use of luggage locating devices is known in the art. More specifically, luggage locating devices heretofore devised and utilized are known to consist basically of familiar, expected and obvious structural configurations, notwithstanding the myriad of designs encompassed by the crowded prior art which have been developed for the fulfillment of countless objectives and requirements.

Known documents include: U.S. Pat. Nos. 6,265,375, 6,342,836, 6,304,183, and 5,804,802

While these devices may fulfill their respective, particularly claimed objectives and requirements, the aforementioned documents do not disclose an improved luggage locating system such as Applicant's present invention. Applicant's invention, through a novel combination of system components, offers its user a range of benefits not provided by other known products.

There are several problems associated with traveling with accompanying luggage via some mass transit system. For instance, in the common case of retrieving luggage from a revolving luggage carousel, commuters often must sort through a staggering assortment of similarly-appearing luggage pieces. This inconvenience increases in proportion to the number of commuters and luggage pieces being retrieved. Specifically, it becomes increasing more difficult to get into position to retrieve luggage and correctly determine which is your luggage. This problem is exaggerated by the fact that a commuter has only a very short time to identify and retrieve his luggage before it passes out of reach. In the event the luggage escapes, the commuter is often forced to wait until the luggage completes its journey around the carousel to make another attempt. Of course, it is easily seen that problems associated with luggage retrieval are exaggerated by the fact that one piece of luggage resembles other luggage in appearance.

In view of the problems associated with luggage retrieval, a great need exists for a system that allows it user to quickly and correctly identify his luggage, thereby allowing the user to plan according to his best chance to retrieve his luggage. Applicant's invention provides such a system. With the click of a button, a system user can cause his luggage tag to illuminate in any number of selected patterns or colors. As such, a user can correctly identify his luggage long before it reaches him. In addition, particular forms of the present invention provide for auditory signals as well. This feature is thought to be most beneficial for the visually impaired and to further personalize each users' luggage.

### SUMMARY OF THE INVENTION

The general purpose of the present invention, which will be described subsequently in greater detail, is to provide a new luggage locating system which has many of the advantages of the luggage locating devices known in the art and many novel features that result in a new luggage locating system which is not anticipated, rendered obvious, suggested, or even implied by any of the known devices, either alone or in any combination thereof.

It is an object of the present invention to provide an improved luggage locator system having a remote member.

It is another object of the present invention to provide an improved luggage system locator having a member reversibly attached to a suitcase.

It is another object of the present invention to provide an improved luggage locator system having one or more light emitting means.

It is another object of the present invention to provide an improved luggage locator system wherein the system components substantially communicate by radio frequency.

It is another object of the present invention to provide an improved luggage locator system that is battery operated.

It is another object of the present invention to provide an improved luggage locator system automatically “shuts down” during periods of non use.

It is another object of the present invention to provide an improved luggage locator system having an energy-saving mechanism based on the relative motion of luggage.

It is another object of the present invention to provide an improved luggage locator system substantially comprised or rigid, high strength material.

It is another object of the present invention to provide an improved luggage locator system that will not interfere with standard luggage transport procedures.

It is yet another object of the present invention that is in compliance with all airport safety rules and regulations.

It is another object of the present invention to provide an improved luggage locator system which may be easily and efficiently manufactured and marketed.

In view of the above and other related objectives, Applicant's invention provides an improved luggage locator system providing several features and benefits with any available systems.

Applicant's invention is thought to be most useful in the context of locating particular items of luggage as that luggage travels along an automated luggage carousel. That is, by communication between a remote member and a suitcase tag member, a users's luggage may be quickly and accurately identified. Of course, it is easily seen that other useful applications of the present invention include any number of contexts where an item of luggage need be located among several other luggage members. This, of course, could be the case in airports, bus stops, train depots, and the like.

The system of the present device is primarily characterized by a remote member (a transmitter) and a luggage tag member (a receiver) in communication with one another via some electromagnetic signal, most likely a radio signal. Upon user input, the remote member sends a signal to the luggage tag member so as to activate the luggage tag member.

The remote member is a small, handheld component capable of sending (and perhaps receiving) electromagnetic signals. During use, the remote member simply responds to a user command. In its most preferred form, the remote member is made of a sturdy material suitable for travel in ones pocket or other carrying means. For example, particular embodiments are envisioned where the remote member reversibly engages a clip member. The clip member may fasten upon any number of convenient carrying locations, such a users belt or purse strap. The remote member, in combination with such a clip member, is particularly useful for preventing the relatively compact remote member from being misplaced. To further guard against misplacement, the remote member may be configured to engage with a key ring (by having an aperture or some ring of its own).

As a matter of convenience, the remote member is of solid, uniform structure having only simple buttons for use. Particularly, most embodiments have a remote member equipped with a “send signal” button and an “on/off” button. Such a simple button configuration provides for extremely straightforward user operation. The electronic component combination of the remote member provide for response to user input and the transmission of an electromagnetic signal. This combination is comprised of capacitors and resistors as known in the art.

The luggage tag member takes the place of a standard luggage tag and can reversibly mate with a piece of luggage by any number of attachment means (i.e., a plastic strap, a slidable tract, or some elastic attachment). In its most preferred form, the luggage tag member is made of a sturdy and rigid material, most likely plastic, hard rubber, fiberglass, or some composite thereof. This feature is particularly useful in that it allows the luggage tag member to repeatedly withstand the rigors of being slammed into other luggage, storage compartments, and transit means. Because of this hard, shell-like exterior, the inner (more sensitive components) of the luggage tag member remain protected throughout their bumpy ride.

Another novel feature of the luggage tag member is its response means. That is, the luggage tag member further contains a microprocessor, which is operationally coupled to a receiving means. The microprocessor decodes the received signal. Said microprocessor is also operationally coupled to a power source and electronically coupled to a light emitting means. Further, said power sources is operationally coupled to a motion sensing means such that when motion is sensed, the power source responds by going into an “awake” operating mode. However, when no motion is sensed for some determined time, the power source is sent to an “asleep” operating mode. Further, said light emitting means is activated by the microprocessor as it decodes the received signal from the remote member.

The light emitting mean of the luggage tag member may be one of several configurations; however, the most useful light emitting means is thought to be a series of light emitting diodes (LED's). Upon activation, the LED combination may flash in any number of predetermined, preselected patterns—further making individual luggage members stand out even in the event several luggage members are equipped with the current invention. Embodiments of the present invention offer both a range of unique LED colors as well as light-emitting patterns. Finally, particular embodiments of this invention shall not exclude the visually impaired. That is, such embodiments are envisioned wherein a particular predetermined, preselected sound response is emitted upon activation. In such embodiments, a micro speaker member, or some equivalent thereof, is further in combination with said battery member, said microprocessor, and perhaps said light emitting means.

Upon activation, the luggage tag member may emphasize any number of personalized features of the luggage. For instance, the light emitting means may illuminate a personal information held by a card holder member. Such a configuration would allow a user to insert an identification card within the card holder member; as light is emitted the card is illuminated, displaying information for all to see. This feature is thought to be particularly useful in the event the luggage member is out of sight from its owner. As the tag member is activated, the bright display of contact information is thought to most likely attract the attention of surrounding people, who would be in the best position to help get the luggage back to its appropriate owner.

Both the remote member and the luggage tag member are battery activated. In its most preferred form, the luggage tag member contains a motion sensing means operationally coupled to the power source. When the luggage tag member comes to rest for a predetermined, preselected time, the motion sensing member sends the battery into “off mode.” Then, when the luggage is moved from its resting place, the motion sensor send the battery back into an active state. Obviously, this feature offers-tremendous benefit in the context of energy consumption and operating life.

The present system, through its combination of novel features and benefits provided, represents a significant improvement in the area of locating luggage. While the system is extremely cost-effective (estimated to be on the order of ten dollars), it is tremendously sturdy and long lasting. The time saved on an individual level in locating luggage through employment of this system will have an extreme cumulative impact on the time saved through wide spread use of this system. finally, while the individual aspects of Applicant's invention may be relatively straightforward, the combination of these seemingly subtle features present a novel and unique system.

### BRIEF DESCRIPTION OF THE DRAWINGS

FIG. 1 is an exploded view of the luggage tag member of the preferred embodiment of the present invention.

FIG. 2 is a perspective view of the luggage tag member of the preferred embodiment of the present invention

FIG. 3 is a perspective view of the remote member of the preferred embodiment of the present invention.

FIG. 4 is a perspective view of the clip member of the preferred embodiment of the present invention.

FIG. 5 is a schematic view of the electronic components of the luggage tag member of the preferred embodiment of the present invention.

FIG. 6 is a schematic view of the electronic components of the remote member of the preferred embodiment of the present invention.

### DETAILED DESCRIPTION OF THE PREFERRED EMBODIMENT

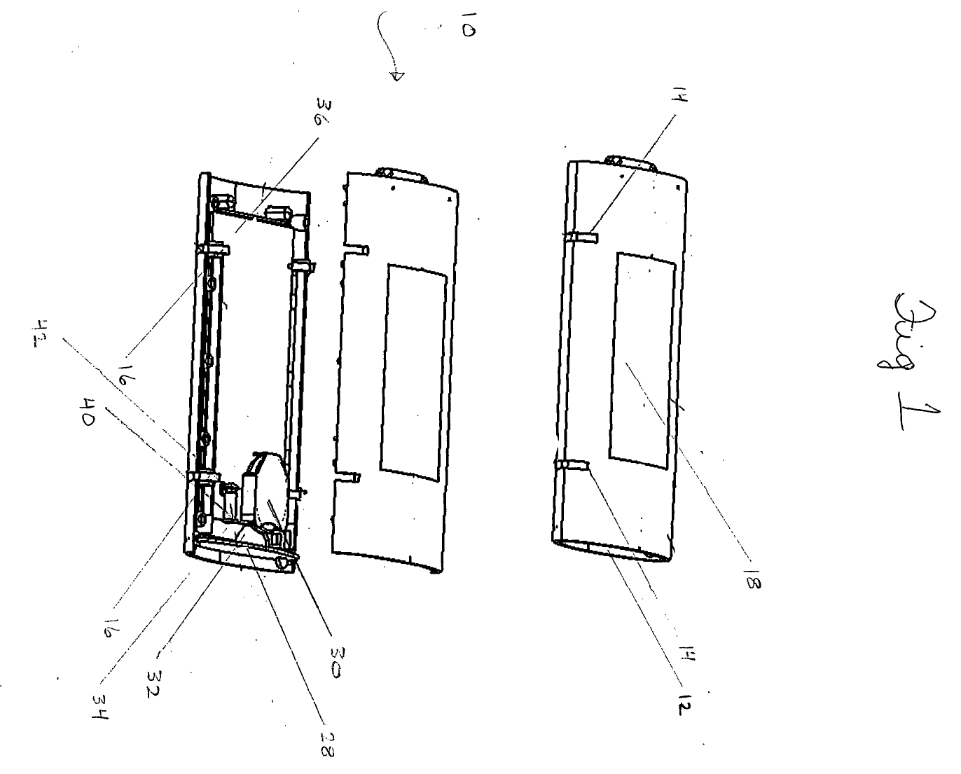

Referring generally to FIG. 1, an exploded view of a luggage tag member is presented. Tag member 10, in the preferred embodiment, is comprised of a relatively strong, rigid material such as hard rubber, plastic, fiberglass, or some composite thereof. This feature, as mentioned, is thought to allow tag member 10 to withstand the impacts absorbed as the luggage member travels through a given transport system.

Tag member 10 is further characterized by top piece 12, which has LED placement apertures 14. Apertures 14, in the preferred embodiment receive LED's 16 so that as top piece 12 fits with other component pieces, LED's 16 securely fit within apertures 14 such that LED's 16 rest flush with top surface 12. Further, while not crucial in and of itself, the shape of top piece 12 is such that components may be contained therein while top piece 12 fits with bottom piece 28 to form a modular frame. In the preferred embodiment, top piece 12 and bottom piece 28 are of a generally rectilinear dimension, each having a concave outer surface. Of course, other useful configurations of each piece will certainly be apparent to those skilled in the art.

Again referring to FIG. 1, bottom piece 28 is essentially shaped in symmetrical proportion to that of top piece 12. That is, as top piece 12 and bottom piece 28 fit with one another, the resulting shape of member 10 is substantially symmetrical about the plane between piece 12 and piece 28. Bottom piece 28 is further formed to hold a combination of inner components that are activated upon operation of the current system.

The form comprised of top piece 12 and bottom piece 28 contains a combination of components therein. That is, microprocessor 32 is operationally coupled to a battery member 30 whereby power is transferred from battery 30 to microprocessor 32. Microprocessor 32 is electronically coupled to a light emitting means 16 and a receiving means 34 such that microprocessor 32 decodes signals received by receiving means 34 and actuates light emitting means 16 according to the received, decoded signals. Operation of tag member 10 generally commences as receiving means 34 receives an electromagnetic signal from remote member 50. Microprocessor 32 decodes the received signal and actuates light emitting mean 16 (which is a plurality of LED's in the preferred embodiment) according to the decoded signal. Receiving means 34 may be any suitable receiver-type component as will be apparent to those skilled in the art. In the preferred embodiment, microprocessor 32 is capable memory storage and capability sufficient to perform several combination of light emitting patterns.

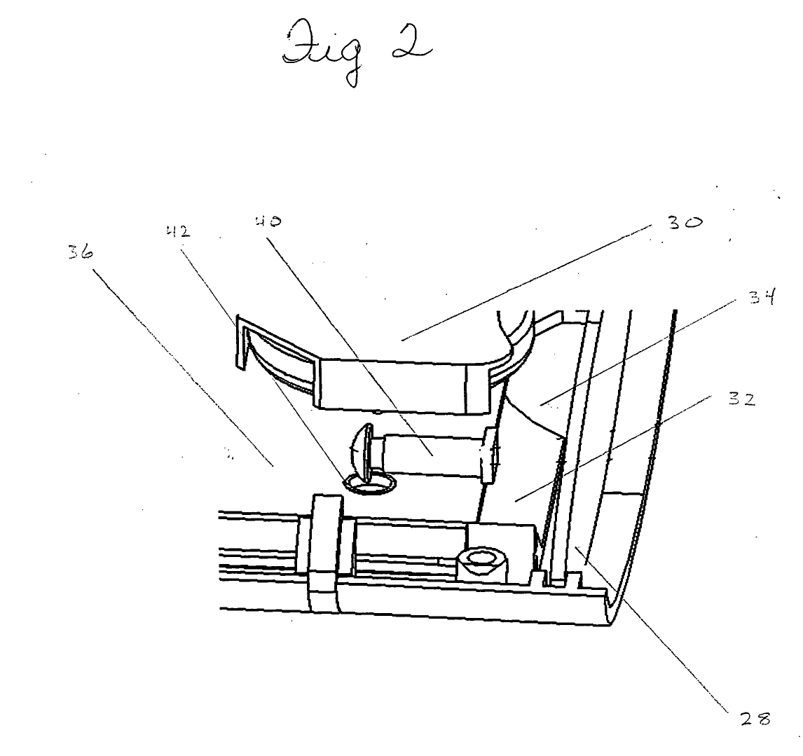

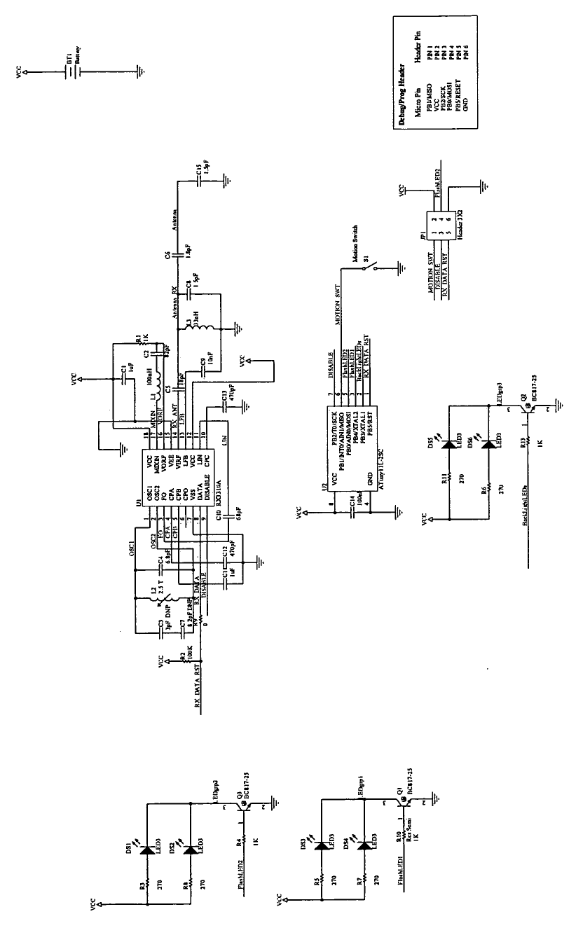

Referring to FIG. 1, FIG. 2, and FIG. 5, a novel feature of the present system is the PCB 36 and motion reactive member 40 combination. In the preferred embodiment, PCB 36 is of a planar shape and is positioned between top piece 12 and bottom piece 28. PCB 36 is operationally coupled with battery member 30 and motion sensing means 40. In the preferred embodiment, motion sensing means 40 comprises a motion reactive member of a general spring configuration that reacts according to velocity changes of member 10. Reactive member 40 extends in a substantially parallel relation to PCB 36 and is so spaced from PCB 36 such that reactive member 40 and PCB 36 rest near each other in adjacent fashion and are not in constant contact. Reactive member 40 is positioned with respect to PCB 36 such that as reactive member 40 moves in reaction to velocity changes of member 10, it comes into contact with PCB 36 at PCB contact 42. Once motion reactive member 40 contacts PCB 36 at PCB contact 42, PCB 36 sends battery member 30 into active mode. However, in the event reactive member 40 does not contact with PCB 36 from some predetermined time (e.g., when member 10 remains at rest), PCB 36 sends battery member 30 to an inactive mode. Such an arrangement allows for tremendous savings in energy consumption and increase in operating life. This feature alone, and in combination with other features of the present invention, sets the present system apart from any of those currently available.

Referring to FIG. 5, the electronic configuration of member 10 allows operation of said member as outlined above. The configuration is of components generally known in the art and combined as shown.

Upon activation, LED's 16 emit light according to preselected, predetermined patterns and/or colors. This feature, is thought to be particularly useful for further personalizing one's luggage in the event several pieces of luggage are equipped with Applicant's invention. The particular arrangement of LED's 16 within top surface 12 is not crucial; however, a pattern is preferred where uniform ligating of top piece 12 is achieved. Such is the case LED's 16 are uniformly spaced about the permitted of top piece 12. While LED's are the preferred light emitting means of the present invention, other useful embodiments are envisioned having a light emitting means comprised of micro bulbs and the like.

As mentioned, particular embodiments of the present invention cater to the visually impaired. In such embodiments, light emitting means 16 is replaced by some speaker member (not pictured) or is in further combination with some speaker member. Said speaker member is electronically coupled to microprocessor 32. The speaker member may be any suitable speaker, such as a micro speaker, capable of fitting with member 10 and producing sufficient auditory signals. Further, these embodiments may allow for both visual and auditory signals in assisting the location of the given luggage member.

Top piece 12 is further characterized by transparent portion 18. Transparent portion 18, in the preferred embodiment is configured to receive and secure a personal information card, such as a contact card or business card and the like. Upon activation, transparent portion 18 allows light to pass through and “light up” the card being displayed therein.

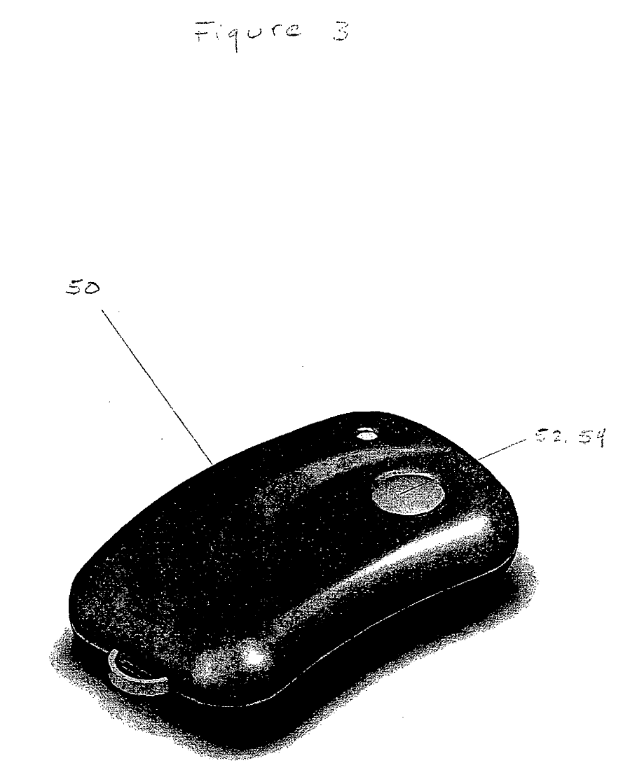

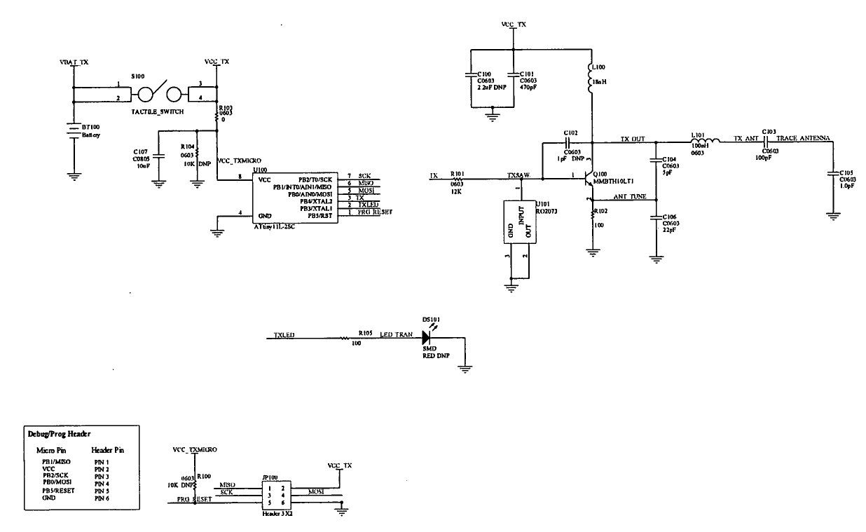

Referring now to FIG. 3, in the preferred embodiment, remote member 50 is a small, handheld member capable of sending (and perhaps receiving) electromagnetic signals. During use, remote member 50 simply responds to a user command entered through a user interface. In the preferred embodiment, said user interface comprises one or more buttons resting along an outer surface of member 50. Referring also now to FIG. 6, a sending means 56 is operational coupled with a power source (not pictured) and electronically coupled with “send signal” button 52 and “on/off” button 54. Sending means 56 sends a signal to member 10 corresponding to the button depressed by a user. As best seen in FIG. 6, the electronic configuration of member 50 allows operation of said member as outlined above. The configuration is of components generally known in the art and combined as shown.

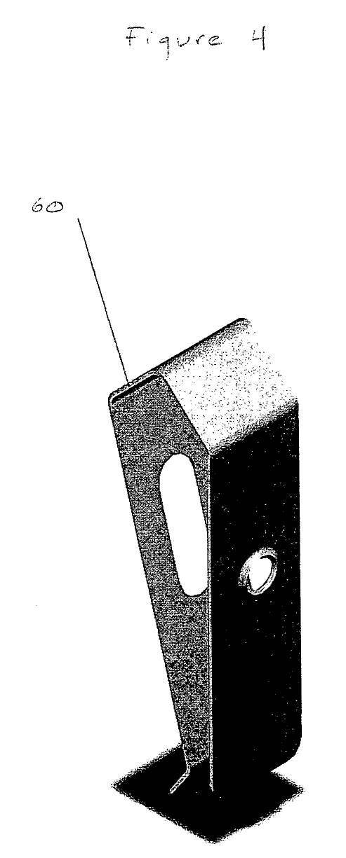

In its most preferred form, remote member 50 is made of a sturdy material suitable for travel in ones pocket or other carrying means. For example, particular embodiments are envisioned where the remote member reversibly engages a clip member 60 (best seen in FIG. 4). Clip member 60 may fasten upon any number of convenient carrying locations, such a users belt or purse strap. Remote member 50, in combination with such clip member 60, is particularly useful for preventing the relatively compact remote member 50 from being misplaced. To further guard against misplacement, remote member 50 may be configured to engage with a key ring (by having an aperture or some ring of its own).

As a matter of convenience, the remote member is of solid, uniform structure having only simple buttons for use. Particularly, most embodiments have a remote member equipped with a “send signal” button 52 and an “on/off” button 54. Such a simple button configuration provides for extremely straightforward user operation. Finally, remote member is receives a standard battery through some standard battery receiving configuration.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An improved luggage locator system, comprising:
a remote member of appropriate size and shape for hand-held operation further comprising
a user interface wherein a user enters desired signals to be sent to a luggage member;
a sending means coupled with said user interface and configured to send an electromagnetic signal to said luggage member;
a remote member power source coupled to said sending means;
said luggage member of appropriate size and shape to serve as a suitable replacement for a luggage tag, further comprising
an attachment means configured to reversibly secure said luggage member to a piece of luggage;
a receiving means coupled to a microprocessor and configured to receive said electromagnetic signal from said remote member;
said microprocessor configured to decode said received signal and actuate a light emitting means according to said received decoded signal, where said microprocessor is coupled to said light emitting means, and where said microprocessor is operationally coupled to a luggage member power source;
a motion sensing means operationally coupled to said luggage member power source configured to react to velocity changes of said luggage member;
said luggage member power source configured to operate in both a power saving, “off” mode or an “awake” mode where said luggage member power source operates in awake mode for a determined time in response to said motion sensing means reaction.

2. The system of claim 1, wherein
said motion sensing means is a reactive spring-base member configuration where said spring actuates about a medial position in reaction to velocity change of said luggage member, where said spring may contact said base member upon reaction to sufficient velocity change, and where said base member sends said luggage member power source to said “awake” mode in response to said contact.

3. The system of claim 1, wherein
said light emitting means is a plurality of LED's peripherally arranged about said luggage member and configured to provide sufficient lighting of the proximity of said luggage member.

4. The system of claim 2, wherein
said light emitting means is a plurality of LED's peripherally arranged about said luggage member and configured to provide sufficient lighting of the proximity of said luggage member.

5. The system of claim 1, wherein
said remote luggage member is further configured to receive and maintain a personal information card, such as a contact card or business card and the like, and where said light emitting means illuminates said card.

6. The system of claim 2, wherein
said remote luggage member is further configured to receive and maintain a personal information card, such as a contact card or business card and the like, and where said light emitting means illuminates said card.

7. The system of claim 3, wherein
said remote luggage member is further configured to receive and maintain a personal information card, such as a contact card or business card and the like, and where said light emitting means illuminates said card.

8. The system of claim 4, wherein
said remote luggage member is further configured to receive and maintain a personal information card, such as a contact card or business card and the like, and where said light emitting means illuminates said card.

9. The system of claim 1, wherein
said remote member and said luggage member are comprised of hard rubber, plastic, fiberglass, or some composite thereof.

10. The system of claim 2, wherein
said remote member and said luggage member are comprised of hard rubber, plastic, fiberglass, or some composite thereof.

11. The system of claim 3, wherein
said remote member and said luggage member are comprised of hard rubber, plastic, fiberglass, or some composite thereof.

12. The system of claim 4, wherein
said remote member and said luggage member are comprised of hard rubber, plastic, fiberglass, or some composite thereof.

13. The system of claim 5, wherein
said remote member and said luggage member are comprised of hard rubber, plastic, fiberglass, or some composite thereof.

14. The system of claim 6, wherein
said remote member and said luggage member are comprised of hard rubber, plastic, fiberglass, or some composite thereof.

15. The system of claim 10, wherein
said remote member and said luggage member are comprised of hard rubber, plastic, fiberglass, or some composite thereof.

16. The system of claim 1, further comprising
a speaker member coupled with said microprocessor wherein said speaker member emits an auditory pattern according to a received decoded signal from said microprocessor.

17. The system of claim 2, further comprising
a speaker member coupled with said microprocessor wherein said speaker member emits an auditory pattern according to a received decoded signal from said microprocessor.

18. The system of claim 3, further comprising
a speaker member coupled with said microprocessor wherein said speaker member emits an auditory pattern according to a received decoded signal from said microprocessor.

19. The system of claim 5, further comprising
a speaker member coupled with said microprocessor wherein said speaker member emits an auditory pattern according to a received decoded signal from said microprocessor.

20. The system of claim 6, further comprising
a speaker member coupled with said microprocessor wherein said speaker member emits an auditory pattern according to a received decoded signal from said microprocessor.

21. The system of claim 8, further comprising
a speaker member coupled with said microprocessor wherein said speaker member emits an auditory pattern according to a received decoded signal from said microprocessor.

22. The system of claim 11, further comprising
a speaker member coupled with said microprocessor wherein said speaker member emits an auditory pattern according to a received decoded signal from said microprocessor.
